(19) United States
(12) Patent Application Publication
(10) Pub. No.: US 2025/0088598 A1
(43) Pub. Date: Mar. 13, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Ryuichi SATO, Kanagawa (JP)

(73) Assignee: FUJIFILM Business Innovation Corp., Tokyo (JP)

(21) Appl. No.: 18/582,573

(22) Filed: Feb. 20, 2024

(30) Foreign Application Priority Data
Sep. 13, 2023 (JP) 2023-148234

(51) Int. Cl. H04N 1/00

(52) U.S. Cl. CPC H04N 1/00925; H04N 1/00896

(57) ABSTRACT

An information processing system includes a processor configured to: issue a notification when an instruction is given to switch a mode in which a job is to be executed from a first mode to a second mode in which a job is executed under operating conditions with less operating noise than the first mode, the notification indicating that an instruction to switch modes has been given, and the notification being issued to a user who has given an instruction to execute a job that may possibly be executed, at least in part, in the second mode.

### CROSS-REFERENCE TO RELATED APPLICATIONS

This application is based on and claims priority under 35 USC 119 from Japanese Patent Application No. 2023-148234 filed Sep. 13, 2023.

### BACKGROUND

### (i) Technical Field

The present disclosure relates to an information processing system, an information processing method, and a non-transitory computer readable medium.

### (ii) Related Art

Known devices have a function to switch modes when executing a job (such as copying, printing, or scanning, for example) between a normal mode and a quiet mode in which the job is executed under operating conditions with less operating noise than the normal mode.

Japanese Unexamined Patent Application Publication No. 2015-152760 describes an image forming device having a function to switch between a standard operating mode and a low-noise operating mode, in which printing based on instructions from an operation unit is executed in the standard operating mode.

Japanese Unexamined Patent Application Publication No. 2012-068293 describes an image forming device that, when instructed to switch modes to a normal mode while a job is running in a quiet mode, executes processing in a mode in which the job finishes early.

### SUMMARY

Incidentally, in some cases, a user different from the user who gave an instruction to execute a job may want to set the mode to the quiet mode. In such cases, if the mode is switched without informing the user who gave the instruction to execute the job about the mode switch, the job may be executed in the quiet mode while the user who gave the instruction to execute the job is unaware of the mode switch. In general, the processing speed in the quiet mode is slower than the processing speed in the normal mode. For this reason, the job may take a longer time to finish, contrary to the intention of the user who gave the instruction to execute the job.

Aspects of non-limiting embodiments of the present disclosure relate to keeping a job from being executed in a mode with a slow processing speed while the user who gave the instruction to execute the job is unaware of a mode switch.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing system including a processor configured to: issue a notification when an instruction is given to switch a mode in which a job is to be executed from a first mode to a second mode in which a job is executed under operating conditions with less operating noise than the first mode, the notification indicating that an instruction to switch modes has been given, and the notification being issued to a user who has given an instruction to execute a job that may possibly be executed, at least in part, in the second mode.

### BRIEF DESCRIPTION OF THE DRAWINGS

An exemplary embodiment of the present disclosure will be described in detail based on the following figures, wherein:

FIG. 1 is a block diagram illustrating a configuration of an overall system according to an exemplary embodiment;

FIG. 2 is a block diagram illustrating a hardware configuration of an image forming device according to the exemplary embodiment;

FIG. 3 is a block diagram illustrating a hardware configuration of a terminal device;

FIG. 4 is a diagram illustrating a flowchart that illustrates the flow of processes by the image forming device according to the exemplary embodiment;

FIG. 5 is a flowchart illustrating the flow of processes according to Example 1;

FIG. 6 is a flowchart illustrating the flow of processes according to Example 2; and

FIG. 7 is a flowchart illustrating the flow of processes according to Example 3.

### DETAILED DESCRIPTION

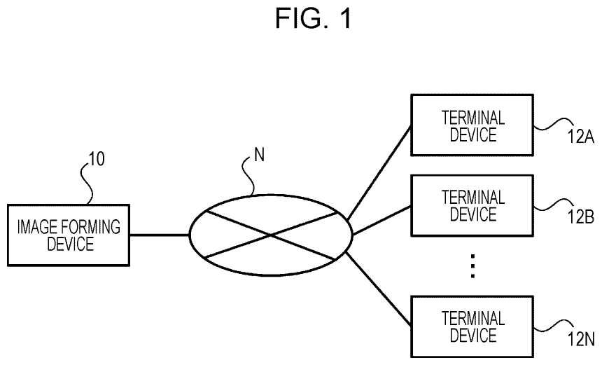

A configuration of an overall system according to an exemplary embodiment will be described with reference to FIG. 1. FIG. 1 is a block diagram illustrating an example of a configuration of an overall system according to the exemplary embodiment.

The overall system according to the exemplary embodiment includes an image forming device 10 and one or more terminal devices.

In the example illustrated in FIG. 1, terminal devices 12A, 12B, . . . , 12N are included in the overall system. Hereinafter, the terminal devices 12A, 12B, . . . , 12N will each be referred to as the “terminal device 12” when not being distinguished individually.

In the example illustrated in FIG. 1, multiple terminal devices 12 are included in the overall system, but a single terminal device 12 may be included in the overall system. Multiple image forming devices 10 may also be included in the overall system. Devices other than the image forming device 10 and the terminal device 12 may also be included in the overall system.

The image forming device 10 and the terminal device 12 communicate with other devices via a communication channel N. The communication channel N is a network, such as a local area network (LAN) or the Internet, for example. The communication channel N may be established by wired communication or by wireless communication such as Wi-Fi®. The communication channel N may also be short-range wireless communication such as Bluetooth® or radio-frequency identification (RFID).

The image forming device 10 is a printer, a scanner, a copier, a facsimile machine, or a multi-function device (device having the functions of multiple devices such as a printer, scanner, and copier, for example). The image forming device 10 executes jobs such as print jobs, scan jobs, and copy jobs. For example, if a user operates the image forming device 10 to thereby instruct the image forming device 10 to execute a job, the image forming device 10 executes the job according to the instruction. In addition, the image forming device 10 executes a job upon receiving an instruction to execute the job from the terminal device 12.

The image forming device 10 has a normal mode and a quiet mode as modes in which to execute jobs. In other words, the image forming device 10 has a normal function and a quiet function as functions by which to execute jobs.

The quiet mode executes a job under operating conditions with less operating noise than the normal mode. In the quiet mode, power consumption and noise are reduced compared to the normal mode. The following describes an example of the quiet mode.

For example, in the normal mode, a function of adjusting the inclination of a sheet using hardware (for example, hardware-based registration) is executed. In the quiet mode, hardware-based registration is not executed. By not using hardware, the accuracy of inclination adjustment is lowered compared to the case of executing hardware-based registration, but power consumption and noise are reduced. For example, in the quiet mode, a function of adjusting the inclination of an image generated by reading an original document (for example, software-based registration) is executed.

For example, when delivering a sheet on which an image has been formed, a process to align the sheet using hardware is executed in the normal mode, but such a process is not executed in the quiet mode. For example, in the quiet mode, set clamps and a tamper for holding down a sheet do not operate, or the number of operations is set lower than the number of operations in the normal mode. With this configuration, in the quiet mode, the positional accuracy of sheet delivery is lowered, but power consumption and noise are reduced compared to the normal mode.

For example, in the case where the image forming device 10 is provided with a post-processing device (such as a device for stapling or a device for creating booklets, for example), in the quiet mode, the preparation time when performing the post-processing is set longer compared to the normal mode. With this configuration, in the quiet mode, post-processing takes a longer time to complete, but noise is reduced compared to the normal mode. In this case, the job processing speed in the quiet mode is slower than the job processing speed in the normal mode.

For example, in the quiet mode, the paper feed pitch is lowered compared to the normal mode. For example, in the quiet mode, a lower paper feed speed is set compared to the normal mode. With this configuration, in the quiet mode, the job processing speed is lowered, but noise is reduced compared to the normal mode. In this case, the job processing speed in the quiet mode is slower than the job processing speed in the normal mode.

The examples given above are merely examples. For instance, the use of an automatic document feeder may be allowed in the normal mode but may not be allowed in the quiet mode. With this configuration, in the quiet mode, the job processing speed is lowered, but power consumption and noise are lowered compared to the normal mode.

In the quiet mode, a lower fusing temperature may be set compared to the normal mode. With this configuration, in the quiet mode, the job processing speed is lowered, but power consumption is lowered compared to the normal mode.

The use of a post-processing device may be allowed in the normal mode but may not be allowed in the quiet mode. With this configuration, in the quiet mode, power consumption and noise are lowered compared to the normal mode.

The operations and processes in the quiet mode described above are merely examples, and one or more of the multiple operations and processes described above may be executed.

The normal mode corresponds to an example of a first mode. The quiet mode corresponds to an example of a second mode.

The terminal device 12 is a device such as a personal computer (hereinafter referred to as a “PC”), a tablet PC, a smartphone, or a mobile phone. For example, if a user operates the terminal device 12 to thereby instruct the image forming device 10 to execute a job, the terminal device 12 transmits job control information to the image forming device 10 via the communication channel N. For example, the job control information includes information indicating the content of the job, the conditions of the job, and execution instructions. The job control information also includes identification information of the terminal device 12 issuing the instruction to execute the job. Upon receiving job control information from the terminal device 12, the image forming device 10 executes the job indicated by the job control information.

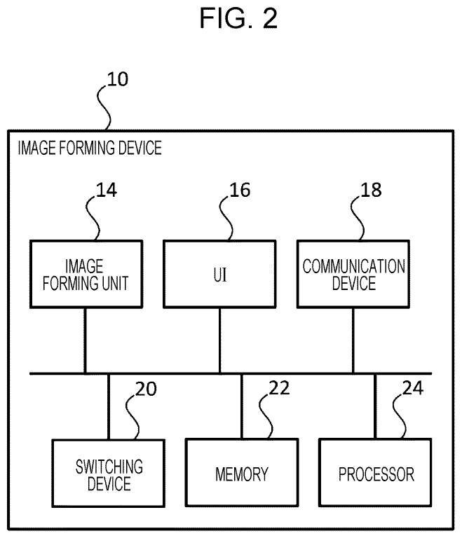

The image forming device 10 according to the exemplary embodiment will be described with reference to FIG. 2. FIG. 2 is a block diagram illustrating a hardware configuration of the image forming device 10 according to the exemplary embodiment.

The image forming device 10 includes an image forming unit 14, a UI 16, a communication device 18, a switching device 20, a memory 22, and a processor 24.

The image forming unit 14 has at least one function from among a print function, a scan function, a copy function, and a facsimile function. Note that the system of printing, the system of scanning, and the like are not particularly limited. For example, an electrophotographic system, an inkjet system, a thermosensitive system, a thermal transfer system, or the like is used as the system of printing.

The UI 16 is a user interface, and includes a display and an operation device. The display is a liquid crystal display, an EL display, or the like. The operation device is a keyboard, mouse, input keys, control panel, or the like. The UI 16 may also be a UI such as a touch panel (for example, an operation panel) combining a display with an operation device.

The communication device 18 includes one or multiple communication interfaces provided with a component such as a communication chip or a communication circuit, and has a function of transmitting information to another device and a function of receiving information from another device. The communication device 18 may have a wireless communication function for short-range wireless communication, Wi-Fi, or the like, and may also have a wired communication function.

The switching device 20 allows a user to manually switch the mode in which a job is to be executed. For example, the switching device 20 is hardware such as a button, a switch, or a lever. When the mode of the image forming device 10 is the normal mode and a user operates the switching device 20 to thereby give an instruction to switch modes, the image forming device 10 switches from the normal mode to the quiet mode. When the mode of the image forming device 10 is the quiet mode and a user operates the switching device 20 to thereby give an instruction to switch modes, the image forming device 10 switches from the quiet mode to the normal mode. Note that the image forming device 10 corresponds to an example of a device body.

The memory 22 is a device containing one or multiple storage areas that store data. For example, the memory 22 is a hard disk drive (HDD), a solid-state drive (SSD), any of various types of memory (such as RAM, DRAM, NVRAM, and ROM, for example), another type of storage device (such as an optical disc, for example), or a combination of the above.

The processor 24 controls operations by each component of the image forming device 10.

For example, the processor 24 accepts a job and executes the job. Specifically, the processor 24 accepts a job and causes the image forming unit 14 to execute the job. When the mode of the image forming device 10 is the normal mode, the processor 24 causes the image forming unit 14 to execute the job in the normal mode. When the image forming device 10 is in the quiet mode, the processor 24 causes the image forming unit 14 to execute the job in the quiet mode.

Also, when a user operates the switching device 20 to thereby give an instruction to switch modes, the processor 24 switches the mode of the image forming device 10 according to the instruction. When the mode of the image forming device 10 is the normal mode and a user operates the switching device 20 to thereby give an instruction to switch modes, the processor 24 switches from the normal mode to the quiet mode. When the mode of the image forming device 10 is the quiet mode and a user operates the switching device 20 to thereby give an instruction to switch modes, the processor 24 switches from the quiet mode to the normal mode.

An instruction to switch modes may also come from the terminal device 12. For example, if a user operates the terminal device 12 to thereby give an instruction to switch modes, the terminal device 12 transmits information indicating the instruction to the image forming device 10. The processor 24 switches modes according to the instruction. When a user uses the terminal device 12 to instruct the image forming device 10 to execute a job, the user may also specify the mode in which the job is to be executed. In this case, the terminal device 12 transmits job control information, including information indicating the mode specified by the user, to the image forming device 10. The processor 24 switches the mode of the image forming device 10 to the mode specified by the user and executes the job.

When instructed to switch the mode in which a job is to be executed from the normal mode to the quiet mode, the processor 24 issues a notification indicating that an instruction to switch modes has been given, the notification being issued to a user who has given an instruction to execute a job that may possibly be executed, at least in part, in the quiet mode. For example, the processor 24 transmits, to the terminal device 12 of an affected user, information indicating that an instruction to switch modes has been given. The information may be displayed on the display of the terminal device 12 or outputted as sound or speech from a speaker of the terminal device 12. With this arrangement, a user who has given an instruction to execute a job may be informed that an instruction to switch the mode from the normal mode to the quiet mode has been given.

A job that may possibly be executed in the quiet mode is a job that is in progress when the instruction to switch the mode from the normal mode to the quiet mode is given, or a job that is scheduled to be executed after the point in time when the switching instruction is given.

For example, in the case where multiple jobs are to be executed by the image forming device 10, the multiple jobs are each executed in a certain order. The order is the order in which the image forming device 10 accepted the jobs, for example. The order may be changed by a user or by an interrupt process. The above-mentioned job that is scheduled is a job to be executed, according to the order, after the point in time when the switching instruction is given.

The execution of a job may also be reserved. For example, if an instruction to execute a job is given with a specified date or time when the job is to be executed, the processor 24 executes the job at the specified date or time. In the case where the reserved date or time is a date or time after the point in time when the switching instruction is given, the reserved job corresponds to an example of the above-mentioned job that is scheduled.

For example, if a user A operates the terminal device 12A to thereby give an instruction to execute a job such as a print job, the image forming device 10 executes the job according to the order. If the mode when the instruction to execute the job is given is the normal mode and an instruction to switch from the normal mode to the quiet mode is given while the job is in progress, the processor 24 transmits, to the terminal device 12A, information indicating that an instruction to switch modes has been given. Similarly, if the job is to be executed after the point in time when the instruction to switch modes is given, the processor 24 transmits, to the terminal device 12A, information indicating that an instruction to switch modes has been given.

Multiple users may each operate their own terminal device 12 to thereby instruct the image forming device 10 to execute jobs. In this case, when instructed to switch the mode in which a job is to be executed from the normal mode to the quiet mode, the processor 24 transmits, to the terminal device 12 of each of the multiple users, information indicating that an instruction to switch modes has been given. This makes it possible to inform the multiple users that an instruction to switch modes has been given.

When instructed to switch the mode in which a job is to be executed from the normal mode to the quiet mode, the processor 24 may also request permission to switch modes from a user who has given an instruction to execute a job that may possibly be executed, at least in part, in the quiet mode.

For example, the processor 24 transmits information indicating a request for permission to switch modes (hereinafter referred to as “request information”) to the terminal device 12 of an affected user. The request information may be displayed on the display of the terminal device 12 or outputted as sound or speech from a speaker of the terminal device 12. The request information may be transmitted to the terminal device 12 by being included in the above-mentioned notification, or may be transmitted to the terminal device 12 separately from the above-mentioned notification.

If a user who has received the request operates the terminal device 12 to permit switching, the terminal device 12 transmits information indicating permission (hereinafter referred to as “permission information”) to the image forming device 10. Upon receiving the permission information, the processor 24 switches the mode from the normal mode to the quiet mode and executes the job in the quiet mode. This arrangement keeps from a job from being executed in the quiet mode, contrary to the intention of the user who gave the instruction to execute the job.

If a user who has received the request operates the terminal device 12 to reject switching permission, the terminal device 12 transmits information indicating rejection (hereinafter referred to as “rejection information”) to the image forming device 10. Upon receiving the rejection information, the processor 24 executes the job in the normal mode without switching modes. After execution of the job is finished, the processor 24 may switch the mode from the normal mode to the quiet mode.

When a user who has received the request does not respond to the request, the processor 24 may execute the job in the normal mode without switching modes. After execution of the job is finished, the processor 24 may switch the mode from the normal mode to the quiet mode.

For example, the processor 24 may not switch modes if the processor 24 receives neither permission information nor rejection information from the terminal device 12 within a predetermined time from the point in time when the request information is transmitted from the image forming device 10 to the terminal device 12.

As another example, the processor 24 may not switch modes if the processor 24 receives neither permission information nor rejection information from the terminal device 12 that is the transmission destination of the request information before the job finishes.

As yet another example, the processor 24 if the processor 24 receives permission information from the terminal device 12 that is the transmission destination of the request information while the job is in progress, the processor 24 may switch the mode from the normal mode to the quiet mode at the point in time when the permission information is received, and execute the job in the quiet mode. If the processor 24 receives rejection information from the terminal device 12 that is the transmission destination of the request information while the job is in progress, the processor 24 may execute the job without switching modes.

When the mode is switched from the normal mode to the quiet mode, the processor 24 may continue to keep the mode in the quiet mode, or switch the mode from the quiet mode to the normal mode according to a predetermined condition.

The predetermined condition is a time-related condition or a job-related condition. For example, if a predetermined time elapses from the point in time when the mode was switched from the normal mode to the quiet mode, the processor 24 switches the mode from the quiet mode to the normal mode. As another example, a job may be executed in the quiet mode, and after the execution finishes, the processor 24 may switch the mode from the quiet mode to the normal mode. As yet another example, a job may be executed in the quiet mode, and when a predetermined time elapses from the point in time when the execution finishes, the processor 24 may switch the mode from the quiet mode to the normal mode.

A default mode of the image forming device 10 may also be set. The normal mode may be set as the default mode, or the quiet mode may be set as the default mode. When the mode is switched to a mode other than the default mode, the processor 24 may revert the mode to the default mode according to the predetermined condition described above.

In the case where the default mode has been set and the mode is switched by the switching device 20, the processor 24 may permit mode switching by only the operation of the switching device 20 while the switched mode is in effect. In this case, the user may operate the switching device 20 to thereby switch modes. If a job is executed after switching modes and the job finishes, the processor 24 may revert the mode to the mode before the switch.

When multiple users give instructions to execute jobs that may possibly be executed in the quiet mode, the processor 24 transmits request information to the terminal device 12 of each of the multiple affected users. If a user who rejects permission is among the multiple affected users (that is, if a terminal device 12 that transmits rejection information to the image forming device 10 is among the multiple terminal devices 12 that receive the request information), the processor 24 executes the job to be executed according to the instruction given by the user who rejects permission, and any jobs to be executed prior to that job, in the normal mode. The processor 24 executes jobs to be executed after the job to be executed according to the instruction given by the user who rejects permission in the quiet mode. If a job being executed at the point in time when the processor 24 receives the instruction to switch modes (that is, a job in progress) will finish within a predetermined time from that point in time, the processor 24 may not transmit information indicating that an instruction to switch modes has been given to the terminal device 12 of the user who gave the instruction to execute the job. Similarly, in this case, the processor 24 may not transmit request information to the terminal device 12 of the user who gave the instruction to execute the job. The processor 24 calculates the time to complete execution of the job from the point in time when an instruction to switch modes is given on the basis of the content of the job, the performance of the device to execute the job, and the like. If the calculated time is within the predetermined time, the processor 24 does not transmit information indicating that an instruction to switch modes has been given or request information to the terminal device 12. This keeps unnecessary notifications from being issued. If the calculated time exceeds the predetermined time, the processor 24 transmits information indicating that an instruction to switch modes has been given and request information to the terminal device 12.

In other words, if the time to finish a job in progress is a predetermined threshold value or less, the processor 24 may not transmit information indicating that an instruction to switch modes has been given or request information to the terminal device 12 of the user who gave the instruction to execute the job. If the time to finish a job in progress exceeds the threshold value, the processor 24 transmits information indicating that an instruction to switch modes has been given and request information to the terminal device 12.

As an example, the time to finish a job in progress is the time to finish the job in the case where the job is executed in the quiet mode. As another example, the time to finish a job in progress may be the time to finish the job in the case where the job is executed in the normal mode.

If a job in progress is a job that uses sheets, such as a print job, and the number of remaining sheets to be processed is a predetermined threshold value or less, the processor 24 may not transmit information indicating that an instruction to switch modes has been given or request information to the terminal device 12 of the user who gave the instruction to execute the job. If the number of remaining sheets to be processed exceeds the threshold value, the processor 24 transmits information indicating that an instruction to switch modes has been given and request information to the terminal device 12.

The processor 24 may also calculate the time to finish a job if the mode is switched from the normal mode to the quiet mode (hereinafter referred to as the “delay time”), and transmit information indicating the delay time (hereinafter referred to as the “delay time information”) to the terminal device 12 of the user who gave the instruction to execute the job.

For example, the processor 24 calculates the delay time on the basis of the content of the job, the performance of the device to be driven in the quiet mode to execute the job, and the like. The processor 24 may transmit the delay time information together with the above-mentioned notification to the terminal device 12, or transmit the delay time information together with the request information to the terminal device 12.

The image forming device 10 may also have multiple quiet modes with different levels of operating noise. In this case, the processor 24 may switch the quiet modes gradually according to mode switching instructions, switch the mode to a user-specified quiet mode, or switch the mode to a quiet mode depending on the job.

The image forming device 10 may also include a lighting device such as an electric light. The processor 24 may change the mode of illumination by the lighting device depending on the mode. For example, the processor 24 may change the color of light that the lighting device emits or change a blink pattern between when the mode is the normal mode and when the mode is the quiet mode. The processor 24 may turn off the lighting device in the normal mode, and turn on the lighting device in the quiet mode. The processor 24 may turn on the lighting device in the normal mode, and turn off the lighting device in the quiet mode. The processor 24 may keep the lighting device on steadily in the normal mode, and turn on the lighting device in the quiet mode. The processor 24 may also perform control that is the reverse of the above. By changing the mode of illumination depending on the mode, users around the image forming device 10 may be informed about the mode of the image forming device 10.

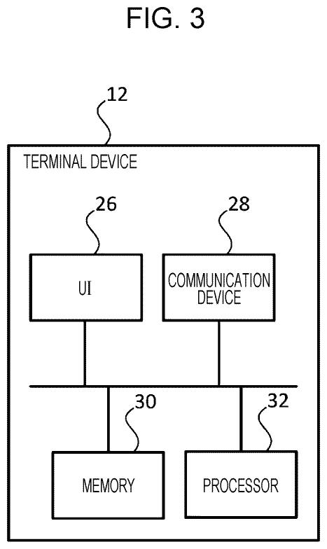

The terminal device 12 will be described with reference to FIG. 3. FIG. 3 is a block diagram illustrating a hardware configuration of the terminal device 12.

The UI 26 is a user interface, and includes a display and an operation device. The display is a liquid crystal display, an EL display, or the like. The operation device is a keyboard, mouse, input keys, control panel, or the like. The UI 26 may also be a UI such as a touch panel combining a display with an operation device. The UI 26 may also include a speaker and a microphone.

The communication device 28 includes one or multiple communication interfaces provided with a component such as a communication chip or a communication circuit, and has a function of transmitting information to another device and a function of receiving information from another device. The communication device 28 may have a wireless communication function for short-range wireless communication, Wi-Fi, or the like, and may also have a wired communication function.

The memory 30 is a device that establishes one or multiple storage locations where data is stored. For example, the memory 30 is a hard disk drive (HDD), a solid-state drive (SSD), any of various types of memory (such as RAM, DRAM, NVRAM, and ROM, for example), another type of storage device (such as an optical disc, for example), or a combination of the above.

The processor 32 controls operations by each component of the terminal device 12.

For example, a user may operate the terminal device 12 to thereby instruct the image forming device 10 to execute a job.

When information indicating that the mode has been switched from the normal mode to the quiet mode is transmitted from the image forming device 10 to the terminal device 12, the processor 32 may cause the display of the UI 26 to display the information or cause a speaker of the UI 26 to output the information as sound or speech.

When request information is transmitted from the image forming device 10 to the terminal device 12, the processor 32 causes the display to display the request information. For example, the processor 32 causes the display of the UI 26 to display a selection screen for selecting whether to permit or reject mode switching.

If the user selects permission on the selection screen, the processor 32 transmits permission information to the image forming device 10.

If the user selects rejection on the selection screen, the processor 32 transmits rejection information to the image forming device 10.

The mode of the image forming device 10 may also be switched by using the terminal device 12. For example, the processor 32 causes the display of the UI 26 to display a switching screen for switching modes. When the user gives an instruction to switch modes on the switching screen, the processor 32 transmits information indicating the instruction to the image forming device 10. For example, when the use specifies the quiet mode on the switching screen, the processor 32 transmits, to the image forming device 10, information indicating an instruction to switch the mode to the quiet mode. The processor 24 of the image forming device 10 switches the mode to the quiet mode according to the instruction. 19

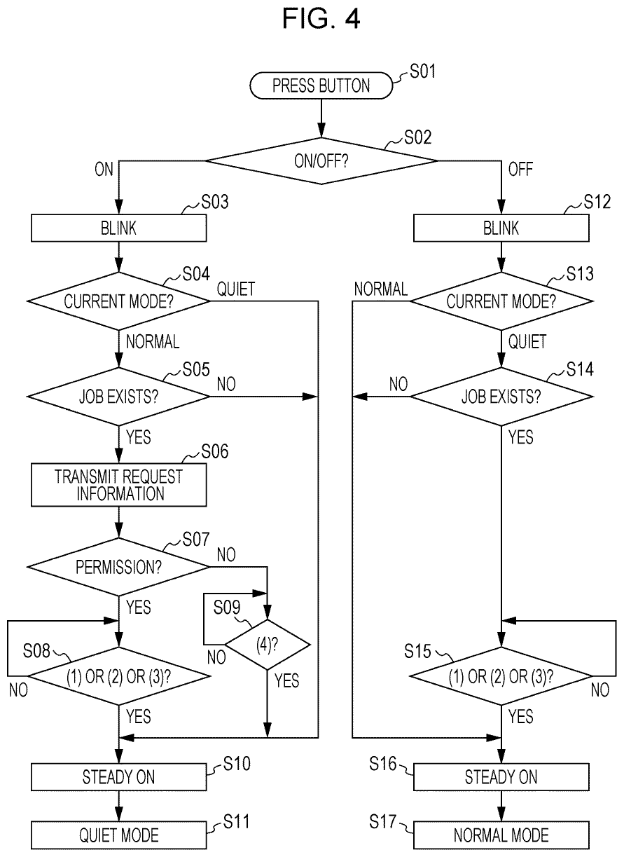

Hereinafter, FIG. 4 will be referenced to describe a flow of processes by the image forming device 10. FIG. 4 is a flowchart illustrating a flow of the processes.

As an example here, the switching device 20 is a button. Hereinafter, the button is referred to as the “switching button”. Also, the mode of the image forming device 10 is switchable according to a switching instruction from the terminal device 12.

First, the switching button is pressed (S01). For example, the switching button is conceivably pressed by a person or other entity around the image forming device 10.

When the switching button is pressed, the processor 32 determines whether the switching button is turned on or off by the press (S02).

Turning on the switching button means giving the image forming device 10 an instruction to switch from the normal mode to the quiet mode. Turning off the switching button means giving the image forming device 10 an instruction to switch from the quiet mode to the normal mode.

For example, it is conceivable that when a person around the image forming device 10 or a user who has given an instruction to execute a job wants to switch the mode from the normal mode to the quiet mode, the person presses the turned-off switching button, thereby turning on the switching button. Conversely, it is conceivable that when a person around the image forming device 10 or a user who has given an instruction to execute a job wants to switch the mode from the quiet mode to the normal mode, the person presses the turned-on switching button, thereby turning off the switching button.

When the switching button is switched from off to on (S02, ON), the processor 24 causes the lighting device provided to the image forming device 10 to blink (S03).

Next, the processor 24 checks the current mode of the image forming device 10 (S04).

If the current mode is the quiet mode (S04, QUIET), the processor 24 turns on the lighting device (S10) and sets the mode to the quiet mode (S11). In this case, the processor 24 maintains the quiet mode. For example, even if the switching button is turned off, the mode may have already been switched to the quiet mode by a switching instruction from the terminal device 12. Since the mode has already been switched to the quiet mode, when the switching button is turned on, the processor 24 maintains the quiet mode without switching modes.

If the current mode is the normal mode (S04, NORMAL), and no job in progress or reserved job exists (S05, NO), the processor 24 turns on the lighting device (S10) and sets the mode to the quiet mode (S11).

If the current mode is the normal mode (S04, NORMAL), and at least one of a job in progress or a reserved job exists (S05, YES), the processor 24 transmits request information to the terminal device 12 of a user who gave an instruction to execute a job (S06). For example, if a job in progress and a reserved job exist, the processor 24 transmits request information to the terminal device 12 of the user who gave the instruction to execute the job in progress and to the terminal device 12 of the user who gave the instruction to execute the reserved job. The processor 24 may transmit delay time information together with the request information to the terminal device 12.

If the user of the terminal device 12 that has received the request information gives permission to switch modes (S07, YES), the processor 24 determines the timing of mode switching (S08). In other words, if the user gives permission to switch modes, permission information is transmitted from the terminal device 12 to the image forming device 10. Upon receiving the permission information, the processor 24 determines the timing of mode switching (S08).

When request information is transmitted to multiple terminal devices 12 and all users give permission to switch modes, the processor 24 determines the timing of mode switching (S08). If a job in progress and a reserved job exist, request information is transmitted to the terminal device 12 of the user who gave the instruction to execute the job in progress and to the terminal device 12 of the user who gave the instruction to execute the reserved job. Upon receiving permission information from the terminal devices 12 of all users, the processor 24 determines the timing of mode switching (S08).

For example, the timing of mode switching is one of the following: (1) for a job in progress, the timing at which the next sheet to be printed is sent to an image output terminal (IOT) (in other words, the feed timing); (2) for a job in progress, in the case where an instruction to execute jobs in multiple sets has been given, the timing at which the execution of the last job finishes; or (3) the timing at which the job in progress finishes.

If one of the above conditions (1) to (3) is met (S08, YES), the processor 24 turns on the lighting device (S10) and sets the mode to the quiet mode (S11). For example, the processor 24 switches the mode from the normal mode to the quiet mode at the timing at which the next sheet to be printed is sent to the IOT.

If none of the above conditions (1) to (3) is met (S08, NO), the processor 24 stands by until one of the conditions (1) to (3) is met.

The conditions (1) to (3) above are merely examples. For example, the processor 24 may also switch the mode to the quiet mode in the middle of a job in progress, even at a timing other than the timings of (1) to (3).

If the user of the terminal device 12 that has received the request information does not give permission to switch modes (S07, NO), the processor 24 determines the timing of mode switching (S09). For example, if the user rejects mode switching, rejection information is transmitted from the terminal device 12 to the image forming device 10. Upon receiving the rejection information, the processor 24 determines the timing of mode switching (S09).

When request information is transmitted to multiple terminal devices 12 and a subset of the users reject mode switching, the processor 24 determines the timing of mode switching (S09). If a job in progress and a reserved job exist, request information is transmitted to the terminal device 12 of the user who gave the instruction to execute the job in progress and to the terminal device 12 of the user who gave the instruction to execute the reserved job. Upon receiving rejection information from the terminal devices 12 of a subset of the users, the processor 24 determines the timing of mode switching (S09).

For example, the timing of mode switching is (4) the timing at which the job in progress and the scheduled job finish. In other words, the timing of mode switching is the timing at which all jobs finish.

If the above condition (4) is met (S09, YES), the processor 24 turns on the lighting device (S10) and sets the mode to the quiet mode (S11).

If the above condition (4) is not met (S09, NO), the processor 24 stands by until the condition (4) is met.

When the switching button is switched from on to off (S02, OFF), the processor 24 causes the lighting device provided to the image forming device 10 to blink (S12).

Next, the processor 24 checks the current mode of the image forming device 10 (S13).

If the current mode is the quiet mode (S13, QUIET), the processor 24 turns on the lighting device (S16) and sets the mode to the normal mode (S17). In this case, the processor 24 maintains the normal mode. For example, even if the switching button is turned on, the mode may have already been switched to the normal mode by a switching instruction from the terminal device 12. Since the mode has already been switched to the normal mode, when the switching button is turned off, the processor 24 maintains the normal mode without switching modes.

If the current mode is the quiet mode (S13, QUIET), and no job in progress or reserved job exists (S14, NO), the processor 24 turns on the lighting device (S16) and sets the mode to the normal mode (S17).

If the current mode is the quiet mode (S13, QUIET), and at least one of a job in progress or a reserved job exists (S14, YES), the processor 24 determines the timing of mode switching (S15).

For example, the timing of mode switching is one of (1) to (3) described above.

If one of the above conditions (1) to (3) is met (S15, YES), the processor 24 turns on the lighting device (S16) and sets the mode to the normal mode (S17). For example, the processor 24 switches the mode from the quiet mode to the normal mode at the timing at which the next sheet to be printed is sent to the IOT.

If none of the above conditions (1) to (3) is met (S15, NO), the processor 24 stands by until one of the conditions (1) to (3) is met.

The following describes specific examples.

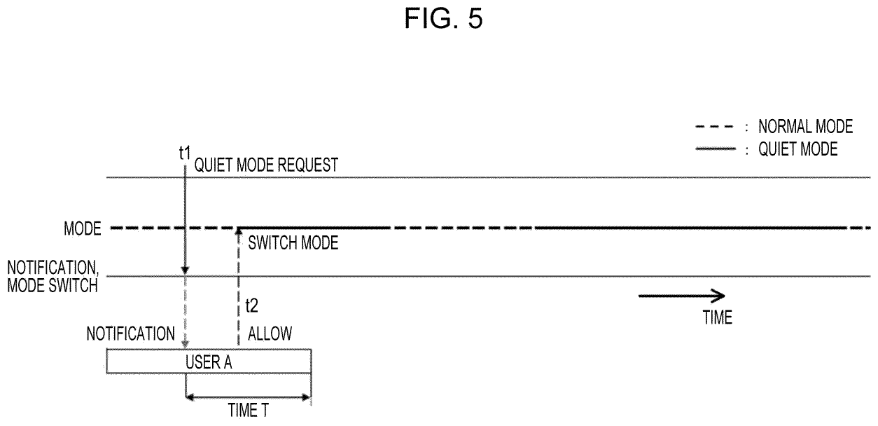

FIG. 5 will be referenced to describe Example 1. FIG. 5 is a flowchart illustrating the flow of processes according to Example 1. FIG. 5 illustrates the timing of job execution, the timing of mode switching, the timing of notification, and the timing of permission. The horizontal axis represents time. A dashed line indicates the normal mode, and a solid line indicates the quiet mode.

At time t1, the switching device 20 is operated, thereby issuing a request to switch the mode from the normal mode to the quiet mode. Additionally, a user A uses their own terminal device 12A to instruct the image forming device 10 to execute a job A. The job A is the job in progress at time t1. At time t1, the job A is being executed in the normal mode. Note that an instruction to switch modes may also come from the terminal device 12.

When the request to switch modes is issued at time t1, the processor 24 of the image forming device 10 notifies the terminal device 12A of the user A that the mode is to be switched. For example, the processor 24 transmits request information to the terminal device 12A. If the user A receiving the request permits mode switching at time t2, the processor 24 switches the mode from the normal mode to the quiet mode at time t2. Thereafter, the processor 24 executes the job A in the quiet mode. This arrangement keeps the job A from being executed in the quiet mode, contrary to the intention of the user A.

After the mode is switched from the normal mode to the quiet mode, the processor 24 switches the mode from the quiet mode to the normal mode according to a predetermined condition. For example, if a predetermined time elapses from the point in time when the mode was switched from the normal mode to the quiet mode, the processor 24 switches the mode from the quiet mode to the normal mode. As another example, a job may be executed in the quiet mode, and after the execution is completed, the processor 24 switches the mode from the quiet mode to the normal mode.

The processor 24 may also calculate the time T to finish the job A. As an example, the processor 24 calculates the time to finish the job A in the case of executing the job A in the quiet mode as the time T. As another example, the processor 24 may calculate the time to finish the job A in the case of executing the job A in the normal mode as the time T.

If the time T is a threshold value or less, the processor 24 may not transmit request information to the terminal device 12A, but if the time T exceeds the threshold value, the processor 24 may transmit request information to the terminal device 12A.

If the remaining number of sheets to be processed in the job A is a threshold value or less, the processor 24 may not transmit request information to the terminal device 12A, but if the time T exceeds the threshold value, the processor 24 may transmit request information to the terminal device 12A.

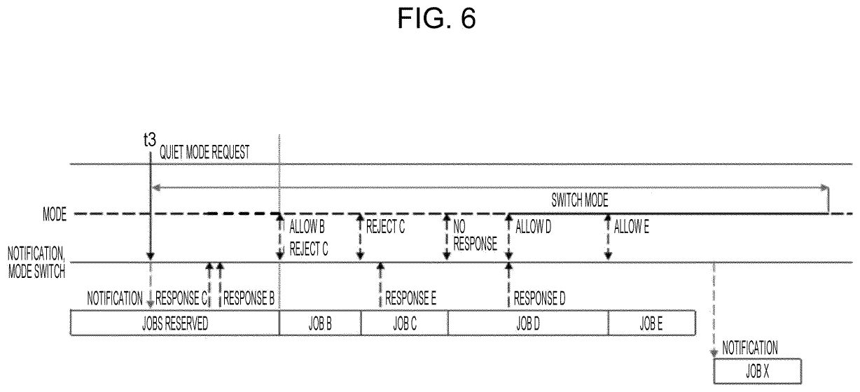

FIG. 6 will be referenced to describe Example 2. FIG. 6 is a flowchart illustrating the flow of processes according to Example 2. FIG. 6 illustrates the timing of job execution, the timing of mode switching, the timing of notification, and the timing of permission. The horizontal axis represents time. A dashed line indicates the normal mode, and a solid line indicates the quiet mode.

In Example 2, the job processing speed in the quiet mode is slower than the job processing speed in the normal mode. For example, the preparation time when performing post-processing is set longer compared to the normal mode, or the paper feed speed is set lower compared to the normal mode.

In Example 2, multiple jobs are reserved for execution. Specifically, jobs B to E are reserved for execution. A user B has given an instruction to execute the job B. A user C has given an instruction to execute the job C. A user D has given an instruction to execute the job D. A user E has given an instruction to execute the job E. The jobs are scheduled to be executed in the following order: B, C, D, E.

At time t3, the switching device 20 is operated, thereby issuing a request to switch the mode from the normal mode to the quiet mode. The jobs B to E are not being executed at time t3, and are scheduled to be executed at times later than time t3. Note that an instruction to switch modes may also come from the terminal device 12.

When the request to switch modes is issued at time t3, the processor 24 of the image forming device 10 notifies the terminal device 12B of the user B, the terminal device 12C of the user C, the terminal device 12D of the user D, and the terminal device 12E of the user E that the mode is to be switched. For example, the processor 24 transmits request information to each of the terminal devices 12B, 12C, 12D, and 12E.

While the jobs are in reserve, that is, before the job B is executed, the users B and C respond to the request. The user B permits mode switching, whereas the user C rejects mode switching. In this case, the processor 24 executes the job C to be executed according to an instruction from the user C who rejects permission, and the job B to be executed before the job C, in the normal mode. In other words, even though the user B who gave the instruction to execute the job B permits mode switching, when the user C who gave the instruction to execute the job C to be executed after the job B rejects mode switching, the processor 24 executes the jobs B and C in the normal mode.

In Example 2, the processing speed in the quiet mode is slower than the processing speed in the normal mode. Therefore, if the job B were executed in the quiet mode, the completion of not only the job B but also the job C would be delayed. Since the user C rejects mode switching, a delay in the completion of the job C is contrary to the intention of the user C. Consequently, executing not only the job C but also the job B in the normal mode keeps the job C from being executed in the quiet mode with a slower processing speed, contrary to the intention of the user C.

The user E responds to the request while the job C is in progress and permits mode switching. The user D does not respond to the request by the point in time when execution of the job D starts (“NO RESPONSE” in FIG. 6). Since the user D has not permitted mode switching, the processor 24 executes the job D in the normal mode.

The user D permits mode switching while the job D is in progress. Since the user E also permits mode switching, the processor 24 switches the mode from the normal mode to the quiet mode at the point in time when the user D permits mode switching. The processor 24 executes the job D in the quiet mode from the middle of the job. In other words, the processor 24 executes the job D in the normal mode before the user D permits switching, and executes the job D in the quiet mode after the user D permits switching. Since the user E has permitted mode switching, the processor 24 executes the job E in the quiet mode.

After the mode is switched from the normal mode to the quiet mode, a user X instructs the image forming device 10 to execute a job X. In this case, the processor 24 transmits information indicating that the mode is the quiet mode to the terminal device 12 of the user X. For example, when the user X sets up the execution of the job X on the terminal device 12, the information indicating that the mode is the quiet mode is displayed on the display of the terminal device 12. This allows the user X to recognize that the current mode is the quiet mode.

Note that when a user does not respond to a request, the processor 24 may also determine that the user permits mode switching. In this control example, the user D does not respond to the request and the user E permits switching, and thus the processor 24 switches the mode from the normal mode to the quiet mode at the point in time when the job C finishes. The processor 24 executes the jobs D and E in the quiet mode.

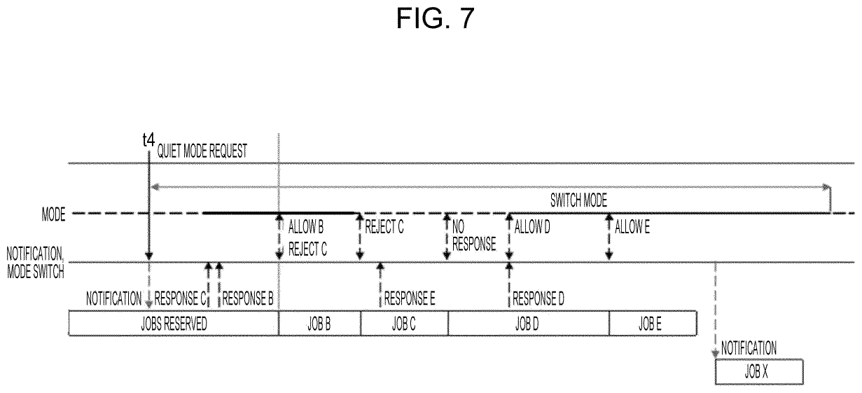

FIG. 7 will be referenced to describe Example 3. FIG. 7 is a flowchart illustrating the flow of processes according to Example 3. FIG. 7 illustrates the timing of job execution, the timing of mode switching, the timing of notification, and the timing of permission. The horizontal axis represents time. A dashed line indicates the normal mode, and a solid line indicates the quiet mode.

In Example 3, the job processing speed in the quiet mode is the same as the job processing speed in the normal mode. For example, in the quiet mode, hardware-based registration is not executed, or a process to align the sheet using hardware is not executed. The preparation time when performing post-processing is the same as the preparation time in the normal mode. The paper feed speed is the same as the speed in the normal mode.

In Example 3, the jobs B to E are reserved for execution, similarly to Example 2. The jobs are scheduled to be executed in the following order: B, C, D, E.

At time t4, the switching device 20 is operated, thereby issuing a request to switch the mode from the normal mode to the quiet mode. The jobs B to E are not being executed at time t4, and are scheduled to be executed at times later than time t4. Note that an instruction to switch modes may also come from the terminal device 12.

When the request to switch modes is issued at time t4, the processor 24 of the image forming device 10 notifies the terminal device 12B of the user B, the terminal device 12C of the user C, the terminal device 12D of the user D, and the terminal device 12E of the user E that the mode is to be switched. For example, the processor 24 transmits request information to each of the terminal devices 12B, 12C, 12D, and 12E.

While the jobs are in reserve, that is, before the job B is executed, the users B and C respond to the request. The user B permits mode switching, whereas the user C rejects mode switching. In this case, the processor 24 executes the job B in the quiet mode and executes the job C in the normal mode.

In Example 3, the job processing speed in the quiet mode is the same as the job processing speed in the normal mode. Accordingly, even if the job B is executed in the quiet mode, the completion of the job C will not be delayed. Therefore, the processor 24 executes the job B in the quiet mode and executes the job C in the normal mode.

The user E responds to the request while the job C is in progress and permits mode switching. The user D does not respond to the request by the point in time when execution of the job D starts (“NO RESPONSE” in FIG. 6). Since the user D has not permitted mode switching, the processor 24 executes the job D in the normal mode.

The user D permits mode switching while the job D is in progress. The processor 24 switches the mode from the normal mode to the quiet mode at the point in time when the user D permits mode switching. The processor 24 executes the job D in the quiet mode from the middle of the job. Since the user E has permitted mode switching, the processor 24 executes the job E in the quiet mode.

After the mode is switched from the normal mode to the quiet mode, a user X instructs the image forming device 10 to execute a job X. In this case, the processor 24 transmits information indicating that the mode is the quiet mode to the terminal device 12 of the user X.

For example, when the user X sets up the execution of the job X on the terminal device 12, the information indicating that the mode is the quiet mode is displayed on the display of the terminal device 12.

In a manner similar to Example 2, when a user does not respond to a request, the processor 24 may also determine that the user permits mode switching.

Some of the functions of the image forming device 10 may also be achieved by another device other than the image forming device 10. In the case where some of the functions of the image forming device 10 are achieved by another device other than the image forming device 10, an information processing system may be formed by the image forming device 10 and the other device. In other words, the functions of the image forming device 10 may be achieved by an information processing system formed from a single device, and may also be achieved by an information processing system that includes multiple devices.

The functions of the image forming device 10 are achieved by the cooperative action of hardware and software as an example. For example, the functions of the image forming device 10 are achieved by causing the processor 24 of the image forming device 10 to read out and execute a program stored in a memory. The program is stored in the memory through a recording medium such as a CD or DVD, or alternatively through a communication channel such as a network.

The exemplary embodiment above is described in terms of modes of the image forming device 10, but processing according to the exemplary embodiment may also be applied to a device other than the image forming device 10.

In the exemplary embodiment above, the term “processor” refers to hardware in a broad sense. Examples of the processor include general processors (e.g., CPU: Central Processing Unit), dedicated processors (e.g., GPU: Graphics Processing Unit, ASIC: Application Integrated Circuit, FPGA: Field Programmable Gate Array, and programmable logic device). In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system comprising a processor configured to:

issue a notification when an instruction is given to switch a mode in which a job is to be executed from a first mode to a second mode in which a job is executed under operating conditions with less operating noise than the first mode, the notification indicating that an instruction to switch modes has been given, and the notification being issued to a user who has given an instruction to execute a job that may possibly be executed, at least in part, in the second mode.

(((2)))

The information processing system according to (((1))), wherein the processor is configured to:

request permission to switch modes from the user; and

execute a job for which permission has been obtained from the user in the second mode.

(((3)))

The information processing system according to (((1))) or (((2))), wherein the job that may possibly be executed in the second mode is a job that is in progress when the instruction to switch the mode from the first mode to the second mode is given, or a job that is scheduled to be executed after a point in time when the switching instruction is given.

(((4)))

The information processing system according to (((2))), wherein the processor is configured such that if the user rejects permission, the processor executes the job to be executed according to the instruction given by the user in the first mode, and after execution of the job to be executed according to the instruction given by the user finishes, switches the mode from the first mode to the second mode.

(((5)))

The information processing system according to (((2))), wherein the processor is configured such that if there is no response regarding permission from the user, the processor executes the job to be executed according to the instruction given by the user in the first mode, and after execution of the job to be executed according to the instruction given by the user finishes, switches the mode from the first mode to the second mode.

(((6)))

The information processing system according to (((2))), wherein the processor is configured such that:

when a plurality of users give instructions to execute jobs that may possibly be executed in the second mode, the processor requests permission to switch modes from the plurality of users; and

if a user who rejects permission is among the plurality of users, the processor executes the job to be executed according to the instruction given by the user who rejects permission, and any jobs to be executed prior to the job to be executed according to the instruction given by the user who rejects permission, in the first mode.

(((7)))

The information processing system according to (((6))), wherein the processor is configured to execute a job to be executed after the job to be executed according to the instruction given by the user who rejects permission in the second mode.

(((8)))

The information processing system according to any one of (((1))) to (((7))), wherein the processor is configured such that if a job being executed at a point in time when an instruction to switch modes is received will finish within a predetermined time from the point in time, the processor does not issue a notification indicating that an instruction to switch modes has been given to the user who gave the instruction to execute the job being executed at the point in time.

(((9)))

The information processing system according to any one of (((1))) to (((8))), further comprising:

a device body that executes jobs; and

a switching device which is provided to the device body and which is used to give an instruction to switch modes, wherein

the processor is configured to accept an instruction given using the switching device.

(((10)))

A program causing a computer to execute a process comprising:

issuing a notification when an instruction is given to switch a mode in which a job is to be executed from a first mode to a second mode in which a job is executed under operating conditions with less operating noise than the first mode, the notification indicating that an instruction to switch modes has been given, and the notification being issued to a user who has given an instruction to execute a job that may possibly be executed, at least in part. in the second mode.

What is claimed is:

1. An information processing system comprising:
a processor configured to:
issue a notification when an instruction is given to switch a mode in which a job is to be executed from a first mode to a second mode in which a job is executed under operating conditions with less operating noise than the first mode, the notification indicating that an instruction to switch modes has been given, and the notification being issued to a user who has given an instruction to execute a job that may possibly be executed, at least in part, in the second mode.

2. The information processing system according to claim 1, wherein the processor is configured to:
request permission to switch modes from the user; and
execute a job for which permission has been obtained from the user in the second mode.

3. The information processing system according to claim 1, wherein the job that may possibly be executed in the second mode is a job that is in progress when the instruction to switch the mode from the first mode to the second mode is given, or a job that is scheduled to be executed after a point in time when the switching instruction is given.

4. The information processing system according to claim 2, wherein the processor is configured such that if the user rejects permission, the processor executes the job to be executed according to the instruction given by the user in the first mode, and after execution of the job to be executed according to the instruction given by the user finishes, switches the mode from the first mode to the second mode.

5. The information processing system according to claim 2, wherein the processor is configured such that if there is no response regarding permission from the user, the processor executes the job to be executed according to the instruction given by the user in the first mode, and after execution of the job to be executed according to the instruction given by the user finishes, switches the mode from the first mode to the second mode.

6. The information processing system according to claim 2, wherein the processor is configured such that:
when a plurality of users give instructions to execute jobs that may possibly be executed in the second mode, the processor requests permission to switch modes from the plurality of users; and
if a user who rejects permission is among the plurality of users, the processor executes the job to be executed according to the instruction given by the user who rejects permission, and any jobs to be executed prior to the job to be executed according to the instruction given by the user who rejects permission, in the first mode.

7. The information processing system according to claim 6, wherein the processor is configured to execute a job to be executed after the job to be executed according to the instruction given by the user who rejects permission in the second mode.

8. The information processing system according to claim 1, wherein the processor is configured such that if a job being executed at a point in time when an instruction to switch modes is received will finish within a predetermined time from the point in time, the processor does not issue a notification indicating that an instruction to switch modes has been given to the user who gave the instruction to execute the job being executed at the point in time.

9. The information processing system according to claim 1, further comprising:
a device body that executes jobs; and
a switching device which is provided to the device body and which is used to give an instruction to switch modes, wherein the processor is configured to accept an instruction given using the switching device.

10. An information processing method comprising:
issuing a notification when an instruction is given to switch a mode in which a job is to be executed from a first mode to a second mode in which a job is executed under operating conditions with less operating noise than the first mode, the notification indicating that an instruction to switch modes has been given, and the notification being issued to a user who has given an instruction to execute a job that may possibly be executed, at least in part, in the second mode.

11. A non-transitory computer readable medium storing a program causing a computer to execute a process comprising:
issuing a notification when an instruction is given to switch a mode in which a job is to be executed from a first mode to a second mode in which a job is executed under operating conditions with less operating noise than the first mode, the notification indicating that an instruction to switch modes has been given, and the notification being issued to a user who has given an instruction to execute a job that may possibly be executed, at least in part, in the second mode.
